(19) United States
(12) Patent Application Publication
(10) Pub. No.: US 2004/0205752 A1
(43) Pub. Date: Oct. 14, 2004

(54) Method and system for management of traffic processor resources supporting UMTS QoS classes

(76) Inventors: Ching-Roung Chou, Naperville, IL (US); Nidal N. Khrais, Flanders, NJ (US); Jae-Hyun Kim, Seoul (KR)

Correspondence Address: Richard J. Minnich, Fay, Sharpe, Fagan, Minnich & McKee, LLP, Seventh Floor, 1100 Superior Avenue, Cleveland, OH, 44114, US

(21) Appl. No.: 10/410,098

(22) Filed: Apr. 9, 2003

(51) Int. Cl. G06F 9/46

(52) U.S. Cl. 718/100

(57) ABSTRACT

This invention relates to a method and apparatus for management of traffic processor resources supporting UMTS Quality of Service (QoS) classes. More particularly, the invention is directed to an approach to processor scheduling and management according to the delay tolerance ratios among the four different QoS classes. Each class has its own share of the processing time under the normal condition. As traffic grows and consequently delay increases, bearers with lower delay tolerance QoS classes (such as conversational and streaming ones) are allowed to preempt the processing of bearers with higher delay tolerance, such as the background class. This approach makes effective use of the critical processor resource for supporting the highest QoS class while protecting the minimum needs of the streaming as well as interactive class and covering the background class with best effort. It schedules the processor in a simple, efficient, but dynamic manner and strives to better satisfy the different delay requirements of different QoS classes as possible.

### BACKGROUND OF THE INVENTION

This invention relates to a method and system for management of traffic processor resources supporting UMTS Quality of Service (QoS) classes. More particularly, the invention is directed to processor scheduling and management based on delay tolerance ratios among the four different QoS classes—each of which has its own share of the processing time under normal conditions. As traffic grows and consequently delay increases, bearers with lower delay tolerance QoS classes (such as conversational and streaming ones) are permitted to preempt the processing of bearers with higher delay tolerance, such as the background class. This approach makes effective use of processor resources for supporting the highest QoS class while still protecting the minimum needs of the streaming, as well as interactive, classes. The background class is treated with best effort. The processor schedules in a simple, efficient, but dynamic manner and strives to better satisfy the different delay requirements of the various QoS classes.

While the invention is particularly directed to the art of traffic management based on quality of service classes defined by UMTS standards, and will be thus described with specific reference thereto, it will be appreciated that the invention may have usefulness in other fields and applications. For example, the invention may have application in other generations of wireless technology.

By way of background, LMTS end-to-end services have certain Quality of Service (QoS) requirements which need to be provided by the underlying network. However, different users running with different applications may have different levels of QoS demand. As such, with reference to FIG. 1, UMTS specifies four different QoS classes (or traffic classes): Class 1 (Conversational), Class 2 (Streaming), Class 3 (Interactive), and Class 4 (Background). The primary distinguishing factor between these classes is the sensitivity to delay. In this regard, conversational class is meant for those services which are very delay/jitter sensitive while Background class is insensitive to delay and jitter. Interactive and Background classes are mainly used to support the traditional Internet applications like WWW, Email, Telnet, FTP and News. Due to less restrictive requirements in delay as compared with Conversational and Streaming classes, both Interactive and Background classes can achieve lower error rates by means of better channel coding and retransmission. The main difference between the Interactive and Background classes is that the former covers mainly interactive applications, such as web browsing and interactive gaming, while the Background class is meant for applications without the need of fast responses, such as file transferring or downloading of Emails. The table of FIG. 1 summarizes the QoS classes specified in UMTS.

Moreover, 3GPP standard (e.g. 3GPP,TS 22.105 v.3.9.0 (2000-06) and 3GPP,TS 23.107 v.3.2.0 (2000-03)) specifies the delay objectives for UMTS services, as shown in the table of FIG. 2. As indicated, the Radio Access Bearer (RAB) delay tolerance is 80% of UMTS delay tolerance; Iu delay tolerance is 20% of RAB delay tolerance

Currently, all traffic processing within the UMTS network elements is treated on a best-effort basis. Processor and resource usage are primarily scheduled with a first-come, first-served (FCFS) discipline, without considering the different needs and characteristics of different 3G applications. In order to satisfy the different levels of demand, service delivery with best effort strategy is not appropriate in many circumstances. A better approach to scheduling processors and allocating resources in a network is desired for accommodating the QoS demands from a diverse group of users.

The present invention contemplates a new and improved traffic management system that resolves the above-referenced difficulties and others.

### SUMMARY OF THE INVENTION

A method and system for management of traffic processor resources supporting UMTS Quality of Service (QoS) classes are provided. The method assigns the processor resource of each QoS class according to the ratio of its delay tolerance as specified by, for example, the 3GPP for the four classes of traffic. Class 1 traffic is given the highest priority due to its high sensitivity to delay and jitter. However, new calls from Class 1 are blocked when the processing time for existing Class 1 traffic exceeds its allocated share for a given period of time in order to prevent the starvation of the users with lower QoS classes. Class 2 and Class 3 are treated based on the ratios of delay tolerance. Best effort strategy is applied to the background traffic of Class 4 with preemption allowed.

In one aspect of the invention, the method comprises 1) determining whether a first queue associated with a first quality of service class is empty, 2) if the first queue is not empty, assigning the traffic processor to process traffic associated with the first quality of service class, 3) if the first queue is empty, determining if a second queue associated with a second quality of service class and a third queue associated with a third quality of service class are both empty, 4) if both the second queue and the third queue are not empty, assigning the traffic processor to process traffic associated with the second and third quality of service classes in a predetermined manner, 5) if all of the first, second, and third queues are empty, assigning the traffic processor to process traffic associated with a fourth quality of service class, and 6) preempting processing of the traffic associated with the fourth quality of service class if traffic associated with the first or second quality of service classes is available for processing.

In another aspect of the invention, a means is provided to implement the method.

In another aspect of the invention, the system comprises a first queue operative to store first data associated with a first quality of service class, a second queue operative to store second data associated with a second quality of service class, a third queue operative to store third data associated with a third quality of service class, a fourth queue operative to store fourth data associated with a fourth quality of service class, and a program module comprising means for 1) determining whether the first queue is empty, 2) assigning the traffic processor to process the first data if the first queue is not empty, 3) determining if the second queue and the third queue are both empty if the first queue is empty, 4) assigning the traffic processor to process the second and third data in a predetermined manner if both the second queue and the third queue are not empty, 5) assigning the traffic processor to process the fourth data if all of the first, second, and third queues are empty, and 6) preempting processing of the fourth data if first or second data is available for processing.

In another aspect of the invention, the processing time shares for traffic of each quality of service class are based on a ratio proportional to delay tolerance.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a table showing the UMTS Quality of Service classes;

FIG. 2 is a table showing the delay requirements for UMTS Quality of Service classes;

FIG. 3 is a diagram illustrating the processing logic of the present invention;

FIG. 4 is a functional illustration of the method according to the present invention;

FIG. 5 is a functional block diagram of a system into which the present invention may be incorporated; and,

FIG. 6 is an example of a functional block diagram of a system according to the present invention.

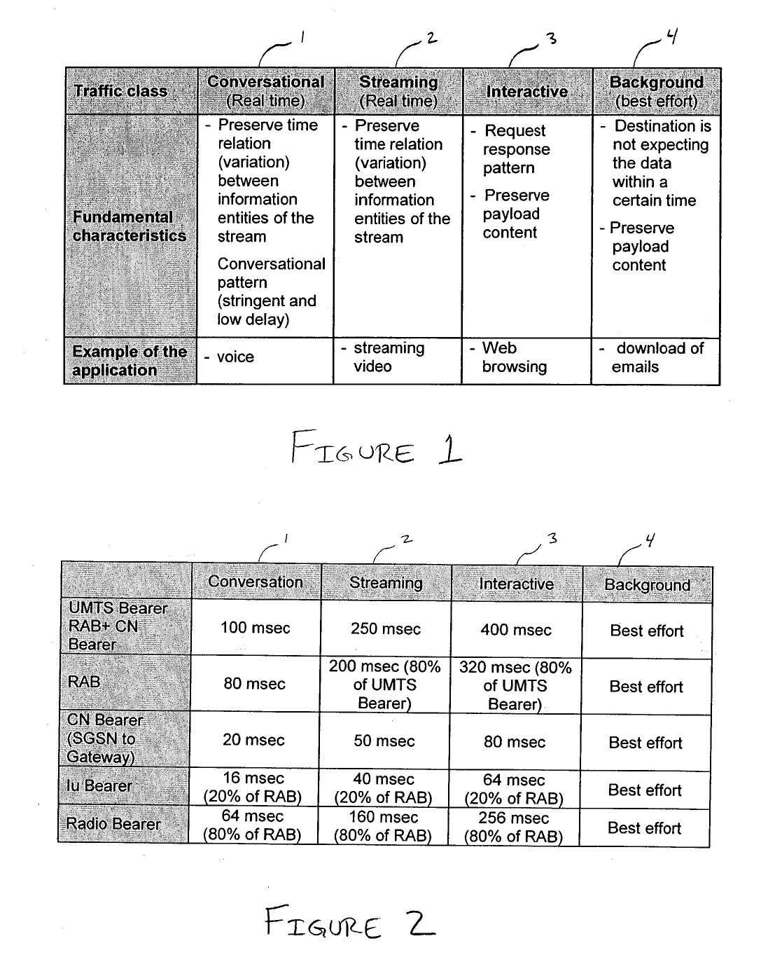

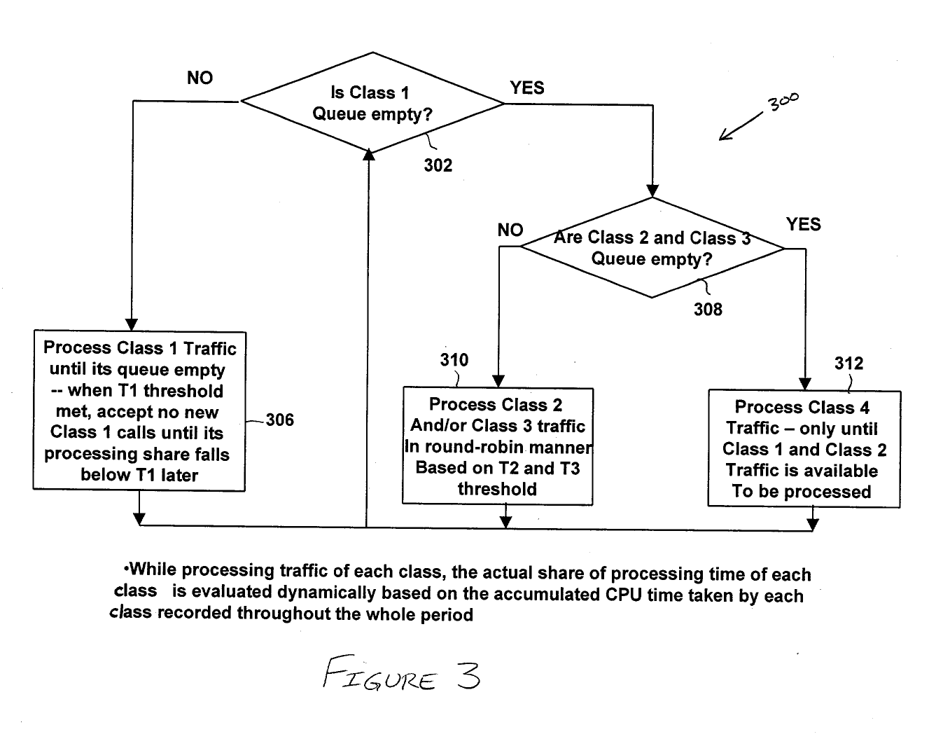

### DETAILED DESCRIPTION OF THE PREFERRED EMBODIMENTS

The present invention involves implementation of a Dynamic Processor Sharing (DPS) strategy—which utilizes a combination of selected aspects of priority and preemptive schemes for scheduling a traffic processor in connection with processing bearer traffic based on various QoS classes. The strategy uses the delay objectives of the different QoS classes delineated in the 3GPP standard 3GPP,TS 22.105 v.3.9.0 (2000-06) and 3GPP,TS 23.107 v.3.2.0 (2000-03) for determining the appropriate share of processor real time for each corresponding class. In an exemplary embodiment described herein, the DPS strategy is implemented in the form of a software control module operative within a Traffic Processsing Unit (TPU) of a Radio Network Controller (RNC) in a wireless network. The software module provides control and operational instructions to the TPU in such a way so as to control four queues of traffic data—each queue being associated with traffic, or data, that corresponds to a particular Quality of Service class. As implemented in this manner, the invention allows for significant advantages relative to traffic management.

According to the present invention, the processor time share initially assigned to, and set as a threshold for, each QoS class is based on the ratio of the delay tolerance of each class to the delay tolerance with respect to others. Let Pᵢ be the share of processor time allocated to class i. We have

$${\sum }_{i = 1}^{4} {P}_{i} = 1 ,$$

and P₄=0, given the four QoS classes defined in UMTS and given that Class 4 traffic is served with best effort. The radio bearer delay budget is then used to calculate the Pᵢ. Let Dᵢ be the delay budget for class i, we have

$$1 = {P}_{1} + {P}_{2} + {P}_{3} \\ {P}_{1} = \frac{{D}_{3}}{{D}_{1}} {P}_{3} \\ {P}_{1} = \frac{{D}_{2}}{{D}_{1}} {P}_{2} \\ {P}_{2} = \frac{{D}_{3}}{{D}_{2}} {P}_{3} \qquad ( 1 )$$

Solving the above equation set (1) with delay budget results in the following ratios, P₁=0.61, P₂=0.24 P₃=0.15, P₄=0, which implies that the share of processor time is allocated 61% for Conversational class, 20% for Streaming class and 15% for Interactive class. Let Tᵢ be the processor time assigned to class i, and C be the unit of processor time, we have

Tᵢ=Pᵢ×C (2)

In this manner, the thresholds for shares of processor time are determined to be: T₁=0.61C, T₂=0.24C, T₃=0.15C, and T₄=0. Thus, for any unit of processor time, 61% of the processor time is set as a threshold for conversational data traffic (Class 1), 24% of the processor time is set as a threshold for streaming data traffic (Class 2), and 15% of the processor time is set as a threshold for interactive data traffic (Class 3). No threshold is set for background data traffic (Class 4). Traffic in this quality of service class (i.e. Class 4) is processed, according to the present invention, only when no other traffic is available for processing.

With the above share (e.g. threshold) assigned to each QoS class, a processor management strategy according to the present invention is used based on priority as well as preemption schemes. As noted above, four queues of traffic data are provided to the system—each queue being associated with traffic, or data, that corresponds to a particular Quality of Service class. For example, the system according to the present invention includes a first queue operative to store first data (e.g. conversational data) associated with a first quality of service class (e.g. Class 1), a second queue operative to store second data (e.g. streaming data) associated with a second quality of service class (e.g. Class 2), a third queue operative to store third data (e.g. interactive data) associated with a third quality of service class (e.g. Class 3), and a fourth queue operative to store fourth data (e.g. background data) associated with a fourth quality of service class (e.g. Class 4). These queues are provided for each traffic processor within the system into which the present invention is incorporated. It is to be appreciated that multiple traffic processors may be provided in an implementation (e.g. multiple traffic processors may be provided in the TPU shown in FIG. 6); however, for convenience, only a single traffic processor will be discussed to describe the present invention.

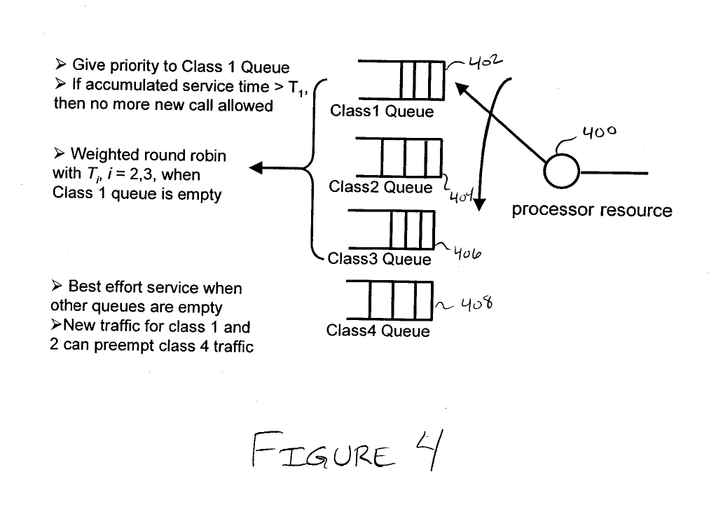

With reference to FIG. 3, a method 300 is shown. As traffic, or data, is processed by the system, a determination is made whether the Class 1 queue is empty (step 302). If not, the processor is assigned to processing Class 1 traffic. When Class 1 traffic load becomes higher and the processor time spent in processing Class 1 traffic exceeded its share of T₁ for a given unit of processor time, the system ceases accepting new call loads of Class 1 traffic, until its processing share falls below T₁ (step 306).

Note that in step 306, only a new call of Class 1 is rejected. The traffic of existing calls of Class 1 are protected and continue to have highest priority in gaining the processor resources—until the call is released. This provides the minimum delay and jitter in processing the Class 1 traffic due to its delay/jitter sensitivity as specified in 3GPP. The purpose of rejecting new calls of Class 1 when T₁ share is exceeded is to prevent the starvation of other lower level QoS classes such that they can also receive a fair share in processing that they deserve. In this regard, as shown, once the existing call load is processed and the Class 1 queue is empty, the system flows back to step 302. Since the Class 1 queue is empty, the flow of the system is directed toward step 308 (which will be described in more detail below).

If Class 1 queue is empty (as determined at step 302), then a determination is made whether both queues for Class 2 and Class 3 are empty (step 308). If not, the processor is assigned to process the traffic in Class 2 and Class 3 queues by round robin manner based on the weighted share of T₂ and T₃ (step 310). So, traffic data in queues for Classes 2 and 3 is processed alternately for periods of time consistent with the thresholds T₂ and T₃ until such thresholds are met, if possible. If a queue for class 2 or 3 is empty, only traffic in the other non-empty queue is processed.

When Class 1, 2, and 3 queues are all empty (as determined by steps 302, 308), the processor is assigned to serve Class 4 traffic (step 312). Upon arrival of new traffic at the queue of either Class 1 or 2 while Class 4 traffic is being processed, preemption of class 4 processing is allowed. When this preemption occurs, the processing returns to step 302.

In step 312, preemption is utilized to provide a higher priority to the traffic of Class 1 and 2. This is also to reduce the delay or jitter for supporting the QoS of Class 1 and 2. On the other hand, preemption of Class 4 for a new arrival of Class 3 traffic is not necessary. The gain in delay for Class 3 services (which are not as delay sensitive) are not worthwhile when compared with the accompanied preemption overhead on the system that would be necessary if preemption for Class 3 traffic would also be implemented. The preemption should not cause any difficulties for the Class 4 traffic because it is delay tolerant and is served in a best effort manner only. The preempted Class 4 traffic processing will be retained at the top of the queue for Class 4, along with a tag indicating the remaining processing needed. As soon as the processor becomes available for Class 4, the preempted Class 4 traffic processing will be resumed and continued.

Throughout the whole process, the processor time spent in processing traffic of each QoS class needs to be monitored and accumulated. The actual share of each QoS class in processing time is derived from the record of accumulated time as needed. It is then used in Steps 306, 308 and 310 for comparison against the target share of T₁, T₂ and T₃ for determining the next traffic event to process accordingly in a given processor unit of time.

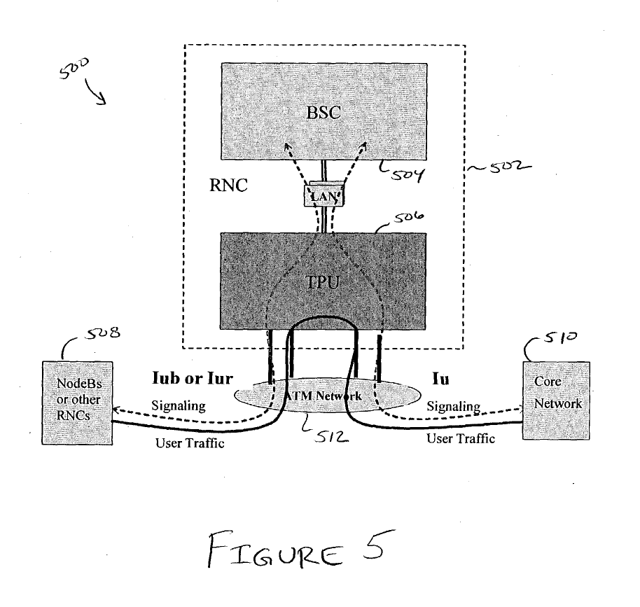

The concept of processor sharing among multiple queues of QoS classes is illustrated in FIG. 4. As shown, processor resource manager 400 gives priority to Class 1 traffic so long as the Class 1 queue 402 is not empty. If the accumulated service time during a given unit of processor time exceeds T₁ (e.g. 0.61C) then no new calls of Class 1 traffic are allowed. This may empty the Class 1 queue and allow the system to determine whether the Class 2 and Class 3 queues 404, 406 are empty. If both are not empty, a weighted round robin processing of the Class 2 and Class 3 queues is accomplished. This processing is maintained until such time as the respective target shares, T₂ and T₃, are achieved. The system then returns its flow to step 302.

So long as traffic is waiting in any of the queues 402, 404 or 406, Class 4 traffic is not processed out of queue 408. However, when the queues 402, 404 and 406 are empty, best effort services are used to process the traffic in the Class 4 queue 408. Significantly, however, if new traffic is accepted in queues 402 or 404, the processing for Class 4 traffic out of queue 408 is preempted. As noted above, the preempted traffic processing is retained at the top of the queue 408, to await further processing.

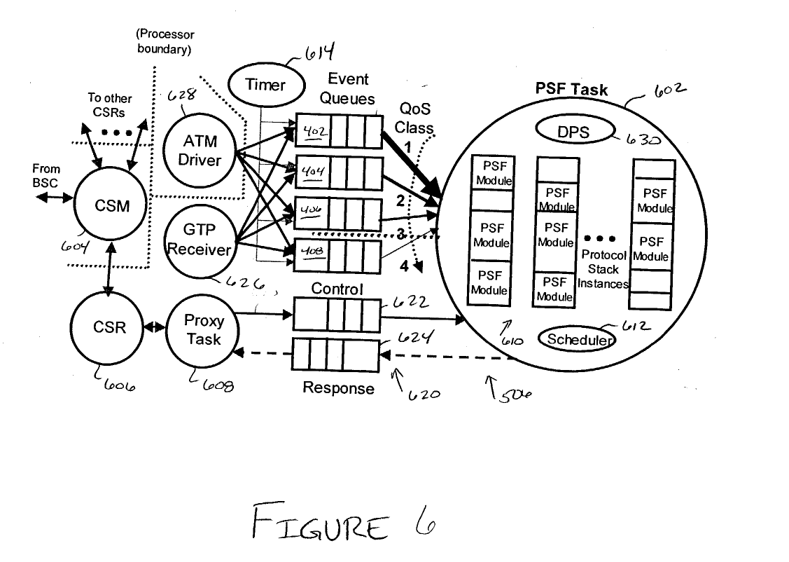

Referring to FIGS. 5-6, an illustrative view of an overall exemplary implementation according to the present invention is provided. Of course, those of skill in the art will recognize that the present invention may be implemented in a variety of manners in a variety of environments.

As shown in FIG. 5, one possible place to apply the present invention is in a Radio Network Controller (RNC) 502, where the radio resources are managed and from which much of the bearer traffic delay time might be contributed. The RNC 502 is a network element within the UMTS Terrestrial Radio Access Network (UTRAN) 500, which controls the use and the integrity of the radio resources within a Radio Network Subsystem (RNS). This disclosure focuses only on the traffic processing and resource allocation within the RNC. The detailed descriptions of the RNC architecture are well known to those skilled in the art.

The principal functions of the RNC 502 include managing radio resources, processing radio signaling, terminating radio access bearers, performing call set up and tear down, processing user voice and data traffic, conducting power control, providing OAM&P capabilities, performing soft and hard handovers, as well as many other functions for supporting circuit switched and always-on packet data services. FIG. 5 shows the flow of traffic through the RNC 502. An RNC 502 may consist of two parts—Base Station Controller (BSC) 504 and Traffic Processing Unit (TPU) 506. The signaling messages flow through the TPU 506 to and from the BSC 504, while the user traffic flows through the TPU directly between the Node B 508 and the Core Network 510 through an ATM network 512. The RNC 502 may also communicate with peer RNCs, where similarly the BSC 504 handles the signaling messages, and the TPU 506 handles the user traffic.

Dividing the RNC functionalities in this way allows the traffic processing part to scale independently of the control part. The implementation of the control plane and the user plane can be separated and evolve independently of each other. In general, the TPU 506 provides the communication service under the control of BSC 504. It hides the distributed implementation and the low-level protocols that are used as transport bearers from the BSC 504. It provides the service via the so-called Service Access Points (SAP) to the UTRAN resources. A SAP is a point on the upper edge of a layer where the use of the service created by the protocol layer can be negotiated. There could be multiple SAPs at the upper edge of various protocol layers such as MAC (Media Access Control) or RLC (Radio Link Control). The BSC-TPU Interface (BTI) allows the BSC to create, destroy, connect, and configure SAPs to manipulate the channel resources in UTRAN and thereby provide the communication services among the Core Network, Node-Bs, Cells and Ues (e.g. user equipment). The TPU 506 provides a set of channels for supporting the control and user traffic in UTRAN. These channels include DTCH (Dedicated Traffic Channel), DCCH (Dedicated Control Channel), CCCH (Common Control Channel), NBAP (NodeB Application Protocol), RANAP (Radio Access Network Application Protocol), RNSAP (Radio Network Subsystem Application Protocol), etc. The approach addressed by the present invention primarily focuses on the case of DTCH (Dedicated Traffic Channel)—where the user bearer traffic with various QoS need is supported. The DTCH (Dedicated Traffic Channel) traffic processing includes terminating the ATM protocol, performing the functions required for framing protocol, timing adjustment, frame selection and distribution, reverse outer loop power control, the MAC-d, RLC (Radio Link Control), possible ciphering, and for packet data calls, PDCP (Packet Data Convergence Protocol) (header compression) and the Iu-PS interface protocols (GTP (GPRS Tunneling Protocol)/UDP (User Datagram Protocol)/IP/AAL5 (ATM Adaption Layer 5)/ATM (Asynchronous Transfer Mode)).

Referring now to FIG. 6, in order to provide the various possible protocol stacks, the TPU 506 uses a platform called Protocol Streams Framework (PSF) which allows the application to specify a set of protocol handlers to be tied together for an execution without requiring context switches. A single PSF task 602 in a traffic processor environment handles the stack for each call assigned to that processor. FIG. 6 shows a PSF task 602 running in parallel with some other tasks in a traffic processor.

The protocol stack of a call is controlled by the BSC 504 (e.g. setup, change, delete, etc.) through the Channel Service Manager (CSM) task 604 that executes on some control processor within the TPU 506. The CSM task 604 then communicates with a Channel Service Representative (CSR) task 606 that executes on each traffic processor in the TPU 506, which in turn interacts with a PSF Proxy task 608 to setup, change and delete the protocol stack for the call. A stack is implemented with a set of PSF Modules 610. These modules are within a single PSF task 602 associated with each traffic processor. This single PSF 602 task contains the PSF modules 610 for all channels and calls assigned to it with a single messaging queue in the current implementation. Any message or event of packet arrival for a specific protocol stack will first be stored in this queue for processing by PSF. The PSF task 602 is a single thread driven by this queue. A Scheduler module 612 within the PSF 602 driven by the time stamped messages from the Timer 614 helps the PSF keep and process the events on schedule. There are also other threads, such CSR, CSR-Proxy, GTP-Receiver, BTI (BSC-TPU Interface), Heart-beat, Logging, etc. running in parallel with PSF on each traffic processor.

The implementation of the present invention may require changes to the PSF, its scheduler module, the GTP-Receiver, the ATM Driver (located in another processor), the Timer, as well as the structure of the single event queue to the PSF.

More specifically, in FIG. 6, a set of queues 402, 404, 406, 408 is added to replace a single event queue of the typical PSF task in order to implement the present invention for supporting the QoS classes. The control path 620, including CSM, CSR, the Proxy task and the queues 622, 624 for control and response messages, would remain the same except the queue for control messages is separated from the other queues created for user plane events. The four additional queues 402, 404, 406, 408 are each used for storing the user plane events of one of the four QoS classes. The events may include packet arrival from GTP_Receiver, frame arrival from ATM_Driver 628, time stamped messages from the Timer 614 (to be handled by Scheduler), etc.

Changes to the GTP_Receiver 626, ATM_Driver 628 and Timer 614 are required such that they can distinguish those events and put them into the appropriate queues corresponding to the associated QoS classes. Determining the traffic type based on QoS and placing data traffic in appropriate queues may be accomplished a number of ways based on the objectives and configuration of the system. The QoS class of a particular traffic is usually associated with its Radio Access Bearer (RAB) corresponding to a particular GTP (GPRS Tunneling Protocol) Tunnel, which is determined and assigned at the setup time of the data call. The GTP (GPRS Tunneling Protocol) Tunnel ID in the header of each packet can then be used as an indicator and mapped into the context information of the particular RAB for determining its associated QoS class. The packet can therefore be placed into the corresponding queue appropriately based on that QoS class information. This is one of the possible ways in implementation.

Another change would, of course, be in the PSF task itself. A Dynamic Processor Sharing (DPS) module 630 is added as an additional module in the PSF task. It performs the priority and preemption based on the five conditions and steps mentioned previously (e.g. in connection with FIGS. 3-4) whenever PSF task 602 is ready to select the next event for processing. It also keeps track of the accumulated processing time for the events of each queue such that they could be used in comparing with the target share of each class in the selection of the next event. One variation in this implementation is that some share for the control messages in the control queue 622 would also be needed in addition to the four share ratios noted. The priority of the control messages versus the traffic events in other queues may also provide for variations. It should be understood that implementation of the invention in the form of the DPS module includes implementation by way of various software programming and hardware techniques that are compatible with the system into which it is incorporated. Depending on the system, for example, the present invention as described in connection with FIGS. 3 and 4 may be implemented in a variety of manners.

In addition, it should be understood that, while UMTS specifies four different QoS classes (or traffic classes): Class 1 (Conversational), Class 2 (Streaming), Class 3 (Interactive), and Class 4 (Background), the present invention is not limited to implementations of using only those classes. As is apparent, the present invention allows for efficient traffic management in a wireless network based on sensitivity to delay. Therefore, the priority that is provided to Class 1 and Class 2 traffic data as described above, could be applied to other classes (of different generations of wireless technology, for example) that exhibit sensitivity to delay. Classes of data based on other criteria may also be used to implement the priority and preemption scheme of the present invention.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for management of traffic through a traffic processor in a wireless network, the traffic processor being associated with traffic classified in a plurality of quality of service classes, each quality of service class having associated therewith a queue, the method comprising steps of:
determining whether a first queue associated with a first quality of service class is empty;
if the first queue is not empty, assigning the traffic processor to process traffic associated with the first quality of service class;
if the first queue is empty, determining if a second queue associated with a second quality of service class and a third queue associated with a third quality of service class are both empty;
if both the second queue and the third queue are not empty, assigning the traffic processor to process traffic associated with the second and third quality of service classes in a predetermined manner;
if all of the first, second, and third queues are empty, assigning the traffic processor to process traffic associated with a fourth quality of service class; and,
preempting processing of the traffic associated with the fourth quality of service class if traffic associated with the first or second quality of service classes is available for processing.

2. The method as set forth in claim 1 wherein the traffic associated with the first quality of service class comprises conversational data.

3. The method as set forth in claim 1 wherein the traffic associated with the second quality of service class comprises streaming data.

4. The method as set forth in claim 1 wherein the traffic associated with the third quality of service class comprises interactive data.

5. The method as set forth in claim 1 wherein the traffic associated with the fourth quality of service class comprises background data.

6. The method as set forth in claim 1 wherein the traffic associated with the first quality of service class and the second quality of service class comprises delay sensitive data.

7. The method as set forth in claim 1 further comprising processing the traffic associated with the first quality of service class for a period of time based on a threshold share of a total unit of processor time.

8. The method as set forth in claim 7 wherein the threshold share is based on a ratio proportional to delay tolerance of the first quality of service class.

9. The method as set forth in claim 1 wherein the predetermined manner of processing the traffic associated with the second and third quality of service classes includes processing in a round-robin manner based on threshold shares of a total unit of processor time.

10. The method as set forth in claim 9 wherein the threshold shares are based on ratios proportional to delay tolerances of the second and third quality of service classes.

11. A system for traffic management in a wireless network having a traffic processor, the system comprising:
a first queue operative to store first data associated with a first quality of service class;
a second queue operative to store second data associated with a second quality of service class;
a third queue operative to store third data associated with a third quality of service class;
a fourth queue operative to store fourth data associated with a fourth quality of service class; and
a program module comprising means for
determining whether the first queue is empty,
assigning the traffic processor to process the first data if the first queue is not empty,
determining if the second queue and the third queue are both empty if the first queue is empty,
assigning the traffic processor to process the second and third data in a predetermined manner if both the second queue and the third queue are not empty,
assigning the traffic processor to process the fourth data if all of the first, second, and third queues are empty, and
preempting processing of the fourth data if first or second data is available for processing.

12. The system as set forth in claim 11 wherein the first data stored in the first queue comprises conversational data.

13. The system as set forth in claim 11 wherein the second data stored in the second queue comprises streaming data.

14. The system as set forth in claim 11 wherein the third data stored in the third queue comprises interactive data.

15. The system as set forth in claim 11 wherein the fourth data stored in the fourth queue comprises background data.

16. The system as set forth in claim 11 wherein the first and second data comprises delay sensitive data.

17. The system as set forth in claim 11 further comprising means for processing the first data for a period of time based on a threshold share of a total unit of processor time.

18. The system as set forth in claim 17 wherein the threshold share is based on a ratio proportional to delay tolerance of the first quality of service class.

19. The system as set forth in claim 11 wherein the predetermined manner of processing the second and third data includes processing in a round-robin manner based on threshold shares of a total unit of processor time.

20. The system as set forth in claim 19 wherein the threshold shares are based on ratios proportional to delay tolerances of the second and third quality of service classes.

21. A system for management of traffic through a traffic processor in a wireless network, the traffic processor being associated with traffic classified in a plurality of quality of service classes, each quality of service class having associated therewith a queue, the system comprising:
means for determining whether a first queue associated with a first quality of service class is empty;
means for determining if a second queue associated with a second quality of service class and a third queue associated with a third quality of service class are both empty if the first queue is empty;
means for assigning the traffic processor to process 1) traffic associated with the first quality of service class if the first queue is not empty, 2) traffic associated with the second and third quality of service classes in a predetermined manner if both the second queue and the third queue are not empty, and 3) traffic associated with a fourth quality of service class if all of the first, second, and third queues are empty; and,
means for preempting processing of the traffic associated with the fourth quality of service class if traffic associated with the first or second quality of service classes is available for processing.

22. The system as set forth in claim 21 further comprising means for processing the traffic associated with the first quality of service class for a period of time based on a threshold share of a total unit of processor time.

23. The system as set forth in claim 22 wherein the threshold share is based on a ratio proportional to delay tolerance of the first quality of service class.

24. The system as set forth in claim 21 wherein the predetermined manner of processing the traffic associated with the second and third quality of service classes includes processing in a round-robin manner based on threshold shares of a total unit of processor time.

25. The system as set forth in claim 24 wherein the threshold shares are based on ratios proportional to delay tolerances of the second and third quality of service classes.

26. The system as set forth in claim 21 wherein the traffic associated with the first quality of service class comprises conversational data.

27. The system as set forth in claim 21 wherein the traffic associated with the second quality of service class comprises streaming data.

28. The system as set forth in claim 21 wherein the traffic associated with the third quality of service class comprises interactive data.

29. The system as set forth in claim 21 wherein the traffic associated with the fourth quality of service class comprises background data.

30. The system as set forth in claim 21 wherein the traffic associated with the first quality of service class and the second quality of service class comprises delay sensitive data.
